(19) United States
(12) Patent Application Publication
(10) Pub. No.: US 2009/0156714 A1
(43) Pub. Date: Jun. 18, 2009

(54) Flame retardant compositions

(76) Inventors: Subramaniam Narayan, West Lafayette, IN (US); Harry Hodgen, Battle Ground, IN (US); James D. Siebecker, West Lafayette, IN (US)

Correspondence Address: Jaimes Sher;CHEMTURA CORPORATION, 199 Benson Road, Middlebury, CT, 06749, US

(21) Appl. No.: 12/283,168

(22) Filed: Sep. 9, 2008

Related U.S. Application Data
(60) Provisional application No. 61/008,056, filed on Dec. 17, 2007.

(51) Int. Cl. C09K 21/08; C08K 5/03

(52) U.S. Cl. 524/81; 252/604

(57) ABSTRACT

A flame retardant composition comprises (a) an organic halide flame retardant in the form of a powder having an average particle size less than or equal 15 microns and (b) an inorganic oxide in an amount up to 5% of the total weight of the organic halide and the inorganic oxide.

### FIELD

The present invention is directed to flame retardant compositions and particularly flame retardant compositions comprising decabromodiphenylethane.

### BACKGROUND

Decabromodiphenylethane (Deca-DPE) is a commercially available material widely used to flame retard various resin systems. The structure of this material is as follows:

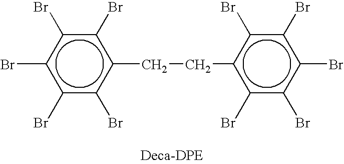

Decabromodiphenylethane is typically produced as low surface area granules and is generally ground to a fine powder to assist its subsequent dispersion in polymer resin systems. However, the resultant decabromodiphenylethane powder has a tendency to cling to storage and feeder hopper walls and other equipment causing problems in transferring and feeding the product during compounding operations. Similar problems are encountered with other finely divided organic halide flame retardants, such as, for example, the structurally related material decabromodiphenylether (Deca):

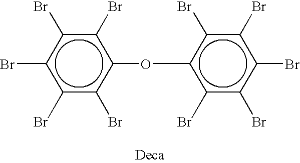

Hence improving the powder flow characteristics of these products to prevent feeding and handling issues currently reported by customers would highly desirable. Improving the flow properties would also result in more consistent feed rates in processing, prevent sticking to equipment, minimize waste and reduce environmental, health and safety concerns.

The problem of achieving consistent flow of fine powders in process equipment is well-known. As exemplified by U.S. Pat. Nos. 4,849,134 and 4,965,021, one way of addressing this issue in the case of decabromodiphenylether is to cold compact the powder into granules which have a particle size between about 2 and about 4 mm and which are substantially free of a binder material that does not possess flame-retardant properties. Unfortunately, this solution is typically useful for polymer additives only when the product can be melt-blended into the formulated polymer matrix. If, as in the case of decabromodiphenylethane the additive has a higher melting point than the polymer matrix and is not miscible with the polymer under typical processing conditions, it is extremely difficult to achieve the desired level of dispersion in the matrix with the compacted material.

The use of flow modifying additives to improve the flow characteristics of powders is known and various types of material, such as PETS (pentaerythritol tetrastearate) waxes, glyceryl stearates and silicon oxides, have been used to modify the flow characteristics of powders for various applications. The technology is particularly known for food and pharmaceutical applications.

For example, International Patent Publication No. WO 2004/039485 discloses that surface-or structure-modified metal oxides are more effective than silica in improving the anti-caking mixtures of pulverulent powdered products.

U.S. Published Patent Application No. 2005/0139039 discloses the use of a binding/lubricating combination of polyethylene wax and ethylene bis-stearamide to aid in the free flowing characteristics of iron-based powders.

U.S. Published Patent Application No. 2006/0134419 describes the use of powder flow aids including fumed silica in a powder polymer composition.

U.S. Pat. No 7,129,371 describes improving the flowability of benzene phosphinic acid by either compaction or blending with an inert anti-caking agent, such as silica.

U.S. Pat. No. 4,234,469 discloses a resin composition consisting essentially of from 30 to 80 percent by weight of polypropylene having a melt index of from 0.5 to 15.0 grams per 10 minutes, from 5 to 25 percent by weight of polyethylene having a melt index of from 0.01 to 2.0 grams per 10 minutes, from 20 to 40 percent by weight of at least one inorganic filler selected from the group consisting of powdered talc, kaolinite, sericite, silica and diatomaceous earth, from 5 to 35 percent by weight of an organic halide flame retarder selected from the group consisting of decabromodiphenylether, dodecachlorododecahydrodimethanobenzocyclooctene and mixtures thereof, and an inorganic antimony compound as a flame retarding assistant in an amount of from ¼ to ½ of the amount of said flame retardant.

According to the present invention, it has now been found that inorganic oxide, such as silica, and especially fumed silica, are particularly useful in improving the flow characteristics of decabromodiphenylethane and other organic halide flame retardants used in fine powder form. These additives can provide a product that flows smoothly through storage and transport equipment, with very little product being left adhering to the walls of hoppers and other process equipment.

### SUMMARY

Accordingly, the invention resides in one aspect in a flame retardant composition comprising (a) an organic halide flame retardant in the form of a powder having an average particle size less than or equal 15 microns and (b) an inorganic oxide in an amount up to 5% of the total weight of the organic halide and the inorganic oxide.

Conveniently, the organic halide flame retardant powder has an average particle size of less than or equal 10 microns, such as less than or equal 5 microns, for example about 1 to about 2 microns.

In one embodiment, the organic halide flame retardant comprises an organic bromide, particularly decabromodiphenylethane.

Conveniently, the inorganic oxide is present in an amount up to 1 wt %, such as from about 0.5 to about 1% of the total weight of the organic halide and the inorganic oxide. Conveniently, the inorganic oxide comprises silica.

In one embodiment, the silica comprises fumed silica and especially fumed silica having a BET surface area of at least 250 m²/g.

In a further aspect, the invention resides in a flame retardant polymer composition comprising a flammable macromolecular material and a blend comprising (a) an organic halide flame retardant in the form of a powder having an average particle size less than or equal 15 microns and (b) an inorganic oxide in an amount up to 5% of the total weight of the organic halide and the inorganic oxide.

In one embodiment, the flammable macromolecular material is high impact polystyrene and said blend is present in an amount between about 10 and about 16% of the total weight of the flame retardant polymer composition.

In another embodiment, the flammable macromolecular material is polypropylene and said blend is present in an amount between about 22 and about 34% of the total weight of the flame retardant polymer composition.

### DETAILED DESCRIPTION

Described herein is a flame retardant composition comprising a finely divided organic halide flame retardant, especially decabromodiphenylethane, together with an inorganic oxide in an amount up to 5 wt % so as to enhance the flow and anti-cling properties of the composition. The resultant composition can be used to enhance the flame retardancy of flammable macromolecular materials, such as polystyrene and polypropylene.

When used as flame retardants, organic halides are typically employed as finely divided powders so as to increase their surface area and hence assist their dispersion in flammable macromolecular materials. Typically, the organic halide flame retardants used herein have an average particle size of less than or equal 15 microns, for example less than or equal to 10 microns, such as less than or equal 5 microns. In one embodiment, the organic halide flame retardants have an average particle size in the range of from about 0.5 microns to about 10 microns, such as in the range of about 1 microns to about 5 microns, for example in the range of from about 1 micron to about 3 microns, such as in the range of from about 1 to about 2 microns. At such fine sizes, the powders frequently show a tendency to cling to storage and feeder hopper walls and other equipment causing problems in transferring and feeding the products during compounding operations.

It has now been found that this problem can be at least partially alleviated by blending the powdered organic halide with particulate inorganic oxide in an amount up to 5%, typically up to 1 wt %, such as from about 0.5 to about 1%, of the total weight of the organic halide and the inorganic oxide. Whereas many inorganic oxides, such as alumina, zinc oxide, magnesium oxide and aluminosilicate clays, have been tested and found to give varying degrees of flow improvement, the best results are normally obtained when silica, and especially fumed silica, is employed as the blend additive. In this respect, it is to be appreciated that fumed silica is silica obtained by the vapor phase hydrolysis of a silicon compound, such as silicon tetrachloride in a hydrogen oxygen flame. Examples of suitable commercially available fumed silicas include the materials supplied by Cabot Corporation under the trade name Cab-O-Sil and the materials supplied by Degussa AG under the trade name Aerosil. High surface area fumed silicas, having a BET surface area of at least 250 m²/g, such as at least 300 m²/g, for example at least 350 m²/g, such as Cab-O-Sil EH-5, seem to show the most promise. Similarly high surface areas are also believed to be beneficial with other inorganic oxides.

Surprisingly, it is found that the addition of the particulate inorganic oxide results in a significant improvement in the flow and feed characteristics of the organic halide flame retardant. The resulting blend does not cling or stick to the metal walls of polymer processing equipments such as feed hoppers, as much as the organic halide itself. The blend also does not bridge the feed throat of hoppers in an extruder and flows much more smoothly into the throat of the extruder compared to organic halide alone.

Moreover, with organic bromide flame retardants, such as decabromodiphenylethane, the addition of the particulate inorganic oxide not only improves the flow and feed characteristics of the material, but also does so without significant change in the color of the composition and, in particular, without significant change in its Yellowness Index and/or its Whiteness Index (WIE).

In addition to decabromodiphenylethane, the inorganic oxides described herein can be employed to improve the flowability of other particulate organic halide flame retardants, such as decabromodiphenylether, tetrabromopthalic anhydride, hexabromocyclododecane, tetrabromobisphenol A, tetrabromobisphenol A bis (2,3-dirbromopropyl ether), tetrabromobisphenol A bis (allyl ether), bis (tribromophenoxy) ethane and halogenated polymeric flame retardants, such as those based on tetrabromobisphenol A (TBBPA) and dibromostyrene (DBS), as well as halogenated aryl ether oligomers and polymers and halogenated epoxy oligomers.

The organic halide/inorganic oxide blends described herein can be used as flame retardants for many different polymer resin systems including thermoplastic polymers, such as polystyrene, high-impact polystyrene (HIPS), poly (acrylonitrile butadiene styrene) (ABS), polycarbonates (PC), PC-ABS blends, polyolefins (such as propylene and ethylene homopolymers and copolymers and thermoplastic olefins), polyesters and/or polyamides. Moreover, the organic halide/inorganic oxide blends can be used with both unfilled polymers and also with polymers filled with glass and other fiber reinforcements. With such polymers, and using decabromodiphenylethane as the organic halide, the loading of the organic halide/silica blend in the polymer formulation required to give a V-0 classification when subjected to the flammability test protocol from Underwriters Laboratories is generally within the following ranges:

| Polymer | Useful | Preferred |
|---|---|---|
| High Impact Polystyrene | 8 to 16 wt % | 11 to 15 wt % |
| Propylene Polymers | 20 to 36 wt % | 22 to 34 wt % |
| Polyethylene | 16 to 28 wt % | 18 to 26 wt % |
| Polyester | 8 to 16 wt % | 8 to 14 wt %. |

The present blends can also be used with thermosetting polymers, such as an epoxy resins, unsaturated polyesters, polyurethanes and/or rubbers. Where the base polymer is a thermosetting polymer, a suitable flammability-reducing amount of the blend employing decabromodiphenylethane as the organic halide is between about 10 wt % and about 35 wt %.

Typical applications for polymer formulations containing the present flame retardant blends include automotive molded components, adhesives and sealants, fabric back coatings, electrical wire and cable jacketing, and electrical and electronic housings, components and connectors. In the area of building and construction, typical uses for the present flame retardant blends include self extinguishing polyolefin films, wire jacketing for wire and cable, backcoating in carpeting and fabric including wall treatments, wood and other natural fiber-filled structural components, roofing materials including roofing membranes, roofing composite materials, and adhesives used to in construction of composite materials. In general consumer products the present flame retardant blends can be used in formulation of appliance parts, housings and components for both attended and unattended appliances where flammability requirements demand.

The invention will now be more particularly described with reference to the following, non-limiting Examples. In the Examples, Yellowness Index (YI) values were measured according to ASTM D-1925 and Whiteness Index (WIE) values were measured according to ASTM E-313.

### Example 1

An antistat based on glycerol monostearate was added to decabromodiphenylethane in a Henschel blender and mixed at 2400 RPM for four minutes. Material exit temperatures ranged from 138 to 152° F. (59 to 67° C.). The resulting blend was discharged smoothly from the blender, with little or no residue left in the blender. The blend had a YI value of about 12.

### Example 2

Several additives were tested to determine their effect on the flow characteristics of decabromodiphenylethane, including calcium stearate, zinc stearate, aluminum oxide, zinc oxide, clay, barium stearate, wax. Each additive was mixed with decabromodiphenylethane in a Wig-L-Bug laboratory mixer and agitated for two minutes. Of all the additives, only zinc stearate showed some effect on flow improvement at ≧2% by weight of decabromodiphenylethane. There was very little material stuck to the sides of the vials and it appeared clear when compared to a sample of decabromodiphenylethane.

### Examples 3 and 4

High surface area untreated fumed silica (as supplied by Cabot Corporation under the trade name Cab-O-Sil EH-5 with a BET surface area of 380 m²/g) and treated fumed silica (as supplied by Cabot Corporation under the trade name Cab-O-Sil TS530 with a BET surface area of 225 m²/g) were each added to a separate sample of decabromodiphenylethane at a loading of 0.5% (by weight of decabromodiphenylethane). Each sample was mixed in a Wig-L-Bug laboratory mixer for two minutes and the resulting blend was transferred to a plastic container and swirled to observe its flow behavior. The sample containing untreated high surface area indicated much better flow improvement compared to a sample of decabromodiphenylethane alone. However, no such improvement was seen in the case of the treated fumed silica sample.

### Example 5

3-4 kgs of decabromodiphenylethane was blended with the untreated high surface area silica employed in Example 3 (0.5% silica by weight of decabromodiphenylethane) in a 10 liter Henschel blender at 1200 rpm for four minutes. The resulting blend was discharged from the mixer and flowed smoothly into the collection bag. There was not much residue left on the sides of the mixer.

### Examples 6 to 9

In order to demonstrate the flow improvement, feeding trials were carried out on a further series of decabromodiphenylethane blends using a Brabender Technologie H-31-DSR28/10 Loss-in-weight single screw feeder. It has an internal agitator with a 28 mm diameter screw and a 35 mm pitch. The feeder is controlled by a Brabender RC-4 controller. Motor speed of the controller is accurate to 0.001%.

The procedure involves zeroing the empty feeder and then loading material into the hopper. The feeder is set to a 24 kg/hr feed rate and run until the controller shuts the feeder down either because of no material left in the hopper (empty) or because the screw has reached maximum speed (material is stuck in hopper and raised screw speed to keep the rate up). A starting and ending feeder weight was recorded to determine how much was left in the feeder. Table I shows data for some of the additives that were evaluated.

All the additives resulted in a significant reduction in the amount of the blend sticking to the walls of the hopper as compared to the sample of decabromodiphenylethane alone. However, the lowest residue level was obtained with the sample containing the high surface area untreated fumed silica, Cab-O-Sil EH-5.

TABLE I
Observations during loss-in-weight feeder experiments

| | | Additive BET | Wt % Additive | % material left | |
|---|---|---|---|---|---|
| Additive | Additive Grade | S.A. (m²/g) | in Blend | in hopper | Comments |
| None | | | | 81.2 | Bridges, ratholes, hangs up on |
| | | | | | walls |
| Glycerol monostearate | Pationic 1042 | | 1.0 | 4.0 | Walls clean, no hang up |
| Treated fumed silica | Cab-O-Sil TS530 | 225 | 0.5 | 12.7 | Hard to clean, hang up on |
| A | | | | | walls/corners |
| Treated fumed silica | Aerosil R8200 | 160 | 0.3 | 20.9 | Ratholes and hang up on walls |
| B | | | | | |
| Untreated fumed | Cab-O-Sil EH-5 | 380 | 0.5 | 3.5 | Walls clean, no hang up, |
| silica, high surface | | | | | discharges smoothly |
| area (as in Example 3) | | | | | |

### Example 10

14.0% of the blend of decabromodiphenylethane/high surface area fumed silica of Example 3 was compounded with high impact polystyrene (HIPS) and an antimony trioxide synergist (3.5%) and tested for flammability as per UL-94 guidelines and shown to have rating of V-0 on a 1/16″ molded bar. Average burn times were 0.4 seconds each on the first and second application with a total burn time (set of 5) of 4 seconds.

### Examples 11 and 12

The decabromodiphenylethane/silica blend of Example 3 was compounded with homopolypropylene containing 10.7 wt % of an antimony trioxide synergist such that the final resin composition contained 32 wt % of the Deca-DPE/silica blend. The resultant resin composition was found to have a V-0 rating in the UL-94 flammability test, on a 1/16″ molded bar. Average burn times were 3 and 1 second respectively on the first and second flame application with a total burn time (set of 5) of twenty seconds.

When compounded with a polypropylene copolymer containing 10.7 wt % antimony trioxide synergist at a loading level of 26 wt %, the same Deca-DPE/silica blend gave a resin composition having a V-0 rating in the UL-94 flammability test on a 1/16″ molded bar. Average burn times were 1.8 and 1.7 seconds on the first and second flame application with a total burn time (set of 5). of 17.5 seconds.

### Examples 13 to 15

The flow trials of Examples 6 to 9 were repeated with blends of decabromodiphenylethane with 0.7 wt % each of alumina (Spectral 100 as supplied by Cabot Corporation), magnesium oxide and zinc oxide. The results are summarized in Table II and show that each oxide produced some improvement in flow properties, although less than that obtained with the untreated fumed silica of Example 3. Color measurements of each blend were also taken and, as shown in Table III, indicated that none of the metal oxide tested had an adverse affect on the color of the blend. The base decabromodiphenylethane had a YI value of 5.88 and a WIE value of 70.81.

TABLE II

| Additive | % Left in Hopper | Comments |
|---|---|---|
| Alumina | 6.5 | Stuck in corners and on walls |
| Magnesium Oxide | 11.8 | Stuck in corners and on walls |
| Zinc Oxide | 4.5 | Some hang-up on walls |

TABLE III

| Additive | YI | WIE |
|---|---|---|
| Alumina | 5.65 | 69.8 |
| Magnesium Oxide | 5.69 | 67.3 |
| Zinc Oxide | 5.73 | 69.1 |

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A flame retardant composition comprising (a) an organic halide flame retardant in the form of a powder having an average particle size less than or equal 15 microns and (b) an inorganic oxide in an amount up to 5% of the total weight of the organic halide and the inorganic oxide.

2. The flame retardant composition of claim 1, wherein the organic halide flame retardant powder has an average particle size of less than or equal 10 microns.

3. The flame retardant composition of claim 1, wherein the organic halide flame retardant powder has an average particle size of less than or equal 5 microns.

4. The flame retardant composition of claim 1, wherein the organic halide flame retardant powder has an average particle size of about 1 to about 2 microns.

5. The flame retardant composition of claim 1, wherein the organic halide flame retardant comprises an organic bromide.

6. The flame retardant composition of claim 1, wherein the organic halide flame retardant comprises decabromodiphenylethane.

7. The flame retardant composition of claim 1, wherein the inorganic oxide is present in an amount up to 1 wt % of the total weight of the organic halide and the inorganic oxide.

8. The flame retardant composition of claim 1, wherein the inorganic oxide is present in an amount from about 0.5 to about 1% of the total weight of the organic halide and the inorganic oxide.

9. The flame retardant composition of claim 1, wherein the inorganic oxide has a BET surface area of at least 250 m²/g.

10. The flame retardant composition of claim 1, wherein the inorganic oxide has a BET surface area of at least 300 m²/g.

11. The flame retardant composition of claim 1, wherein the inorganic oxide is selected from at least one of silica, alumina, zinc oxide, magnesium oxide and aluminosilicate clays.

12. The flame retardant composition of claim 1, wherein the inorganic oxide comprises silica.

13. The flame retardant composition of claim 12, wherein the silica comprises fumed silica.

14. A flame retardant polymer composition comprising a flammable macromolecular material and a blend comprising (a) an organic halide flame retardant in the form of a powder having an average particle size less than or equal 15 microns and (b) inorganic oxide in an amount up to 5% of the total weight of the organic halide and the inorganic oxide.

15. The flame retardant polymer composition of claim 14, wherein the organic halide flame retardant powder has an average particle size of less than or equal 10 microns.

16. The flame retardant polymer composition of claim 14, wherein the organic halide flame retardant powder has an average particle size of less than or equal 5 microns.

17. The flame retardant polymer composition of claim 14, wherein the organic halide flame retardant powder has an average particle size of about 1 to about 2 microns.

18. The flame retardant polymer composition of claim 14, wherein the organic halide flame retardant comprises an organic bromide.

19. The flame retardant polymer composition of claim 14, wherein the organic halide flame retardant comprises decabromodiphenylethane.

20. The flame retardant polymer composition of claim 14, wherein the inorganic oxide is present in an amount up to 1 wt % of the total weight of the organic halide and the inorganic oxide.

21. The flame retardant polymer composition of claim 14, wherein the inorganic oxide is present in an amount from about 0.5 to about 1% of the total weight of the organic halide and the inorganic oxide.

22. The flame retardant polymer composition of claim 14, wherein the inorganic oxide has a BET surface area of at least 250 m²/g.

23. The flame retardant polymer composition of claim 14, wherein the inorganic oxide has a BET surface area of at least 300 m²/g.

24. The flame retardant polymer composition of claim 14, wherein the inorganic oxide is selected from at least one of silica, alumina, zinc oxide, magnesium oxide and aluminosilicate clays.

25. The flame retardant polymer composition of claim 14, wherein the inorganic oxide comprises silica.

26. The flame retardant polymer composition of claim 25, wherein the silica comprises fumed silica.

27. The flame retardant polymer composition of claim 14, wherein the flammable macromolecular material is high impact polystyrene and the blend is present in an amount between about 8 and about 16% of the total weight of the flame retardant polymer composition.

28. The flame retardant polymer composition of claim 14, wherein the flammable macromolecular material is a propylene homopolymer or copolymer and the blend is present in an amount between about 20 and about 36% of the total weight of the flame retardant polymer composition.

29. The flame retardant polymer composition of claim 14, wherein the flammable macromolecular material is polyethylene and the blend is present in an amount between about 16 and about 28% of the total weight of the flame retardant polymer composition.

30. The flame retardant polymer composition of claim 14, wherein the flammable macromolecular material is a polyester and the blend is present in an amount between about 8 and about 16% of the total weight of the flame retardant polymer composition.

31. The flame retardant polymer composition of claim 14, wherein the flammable macromolecular material is a thermosetting polymer and the blend is present in an amount between about 10 and about 35% of the total weight of the flame retardant polymer composition.
